(19) United States
(12) Patent Application Publication
(10) Pub. No.: US 2025/0023349 A1
(43) Pub. Date: Jan. 16, 2025

(54) Method and System for Performing Asset and Energy Management for an Electrical Distribution System

(71) Applicant: ABB S.p.A., Milano (IT)

(72) Inventors: Mayukha Pal, Sangareddy (IN); Barin Karmakar, Kolkata (IN); Vineeth Reddy, Secunderabad (IN)

(73) Assignee: ABB S.p.A., Milano (IT)

(21) Appl. No.: 18/899,042

(22) Filed: Sep. 27, 2024

Related U.S. Application Data
(63) Continuation of application No. PCT/IB2022/052820, filed on Mar. 28, 2022.

(51) Int. Cl. H02J 3/00; H02J 13/00

(52) U.S. Cl. CPC H02J 3/0012; H02J 13/00002; H02J 2203/10; H02J 2203/20

(57) ABSTRACT

A method for performing asset and energy management for an electrical distribution system includes receiving measurement data of plurality of input variables of electrical distribution system; generating coefficient matrix for each output variable used for asset and energy management, based on effects of plurality of input variables on corresponding output variable, using sparse regression. The coefficient matrix comprises one or more input variables from plurality of input variables. Furthermore, the method comprises determining plurality of system representations for each output variable, based on corresponding coefficient matrix. Each of plurality of system representations indicates relationship between one or more input variables and the corresponding output variable. Thereafter, the method comprises identifying system representation from plurality of system representations to train machine learning model for predicting value of output variable, for performing asset and energy management for electrical distribution system.

### CROSS-REFERENCE TO RELATED APPLICATIONS

The instant application claims priority to International Patent Application No. PCT/IB2022/052820, filed Mar. 28, 2022, which is incorporated herein in its entirety by reference.

### FIELD OF THE DISCLOSURE

The present disclosure generally relates to data analytics in electrical distribution systems and, more particularly, to a system and a method for performing asset and energy management for an electrical distribution system.

### BACKGROUND OF THE INVENTION

Electrical distribution system is an electrical network which distributes electrical energy to an end user for utilization. The electrical distribution system may include multiple components such as, supply lines, transformers, switchgears, circuit breakers, switches, relays, fuses, cooling circuits, receptacles, utilization components, and the like. Components such as, switchgears, circuit breakers, switches, relays, fuses, and the like, protect other components of the electrical distribution system such as, the supply lines, the transformers, the utilization components, and the like, by monitoring conditions of the other components. The main aim of the electrical distribution systems is to provide sustainable, affordable, and uninterrupted power supply. To achieve this, asset management and energy management play a crucial role. Typically, asset management includes monitoring behaviour of assets of the electrical distribution systems and restoring faults that result in supply interruption for end users. The asset management is required to maintain functionality of the assets and to minimize breakdowns of the assets, to provide sustainable and uninterrupted power supply. For instance, consider there may be a short circuit on a power distribution line. The power distribution line may be connected to multiple assets of the electrical distribution systems. The asset management helps to identify the asset responsible for short circuit in the power distribution line.

While the energy management is required to plan energy production and energy consumption. Data related to multiple variables of the electrical distribution systems is used to perform the asset and energy management. The electrical distribution system includes multiple constituting components including electrical and mechanical components, and hence includes multiple variables such as electrical and mechanical variables. Generally, correlation between these variables is complex as the variables exhibit non-linearity i.e., there is no direct relationship between the variables and the relationship between the variables is not predictable from a straight line. In a non-linear relationship, changes in an output variable do not change in direct proportion to changes in input variables.

Conventional systems that predict data for performing the asset and energy management implement linear data modelling and analytics using machine learning. However, these systems may result into inaccurate or highly error prone predictions as the complexity due to the non-linearity and the complex correlation between the variables are not considered.

### BRIEF SUMMARY OF THE INVENTION

In an embodiment, the present disclosure discloses a method of performing asset and energy management for an electrical distribution system. The method comprises receiving measurement data of a plurality of input variables of an electrical distribution system, from one or more sensors associated with the electrical distribution system. Further, the method comprises generating a coefficient matrix for each output variable from one or more output variables used for asset and energy management. The coefficient matrix is generated based on effects of the plurality of input variables on corresponding output variable, using sparse regression on the measurement data. The coefficient matrix comprises one or more input variables from the plurality of input variables. Furthermore, the method comprises determining a plurality of system representations for each output variable, based on the corresponding coefficient matrix. Each of the plurality of system representations indicates a relationship between the one or more input variables and the corresponding output variable. Thereafter, the method comprises identifying a system representation from the plurality of system representations, for each output variable. The system representation is used to train a machine learning model for predicting a value of the corresponding output variable, for performing the asset and energy management for the electrical distribution system.

In another embodiment, the present disclosure discloses a computing system for performing asset and energy management for an electrical distribution system. The computing system comprises a processor and a memory. The processor is configured to receive measurement data of a plurality of input variables of an electrical distribution system, from one or more sensors associated with the electrical distribution system. Further, the processor is configured to generate a coefficient matrix for each output variable from one or more output variables used for asset and energy management. The coefficient matrix is generated based on effects of the plurality of input variables on corresponding output variable, using sparse regression on the measurement data. The coefficient matrix comprises one or more input variables from the plurality of input variables. Furthermore, the processor is configured to determine a plurality of system representations for each output variable, based on the corresponding coefficient matrix. Each of the plurality of system representations indicates a relationship between the one or more input variables and the corresponding output variable. Thereafter, the processor is configured to identify a system representation from the plurality of system representations, for each output variable. The system representation is used to train a machine learning model for predicting a value of the corresponding output variable, for performing the asset and energy management for the electrical distribution system.

### BRIEF DESCRIPTION OF THE SEVERAL VIEWS OF THE DRAWING(S)

FIG. 1 is a diagram of an exemplary environment for performing asset and energy management for an electrical distribution system in accordance with some embodiments of the present disclosure.

FIG. 2 is a detailed diagram of a computing system for performing the asset and energy management for the electrical distribution system in accordance with some embodiments of the present disclosure.

FIG. 3 is a flowchart illustrating method steps for performing the asset and energy management for the electrical distribution system, in accordance with some embodiments of the present disclosure.

FIG. 4 is a block diagram of an exemplary computer system for performing the asset and energy management for the electrical distribution system in accordance with some embodiments of the present disclosure.

### DETAILED DESCRIPTION OF THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments. The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Asset and energy management are an essential requirement for the electrical distribution systems to ensure availability, minimum breakdown, monitor energy consumption, and the like, of electrical assets. Generally, electrical distribution systems comprise multiple components. These components may include multiple variables such as, electrical, and mechanical variables. There is a complex correlation between the variables as the variables exhibit strong non-linearities, parametric dependencies, multiscale phenomena, and the like, making resulting system behavior very complex. In a non-linear relationship, changes in an output variable do not change in direct proportion to changes in any of input variables. Further, multiple input variables may contribute to the output variables making prediction of the output variable a difficult process. For instance, there can be multiple variables contributing to electric load. Thus, making accurate prediction of the electric load a difficult process. The input variables involve uncertainties and includes no direct relationship with the output variable. Moreover, the output variable is characterized to be non-linear that can undergo rapid changes due to environmental changes, addition of assets, demand patterns, maintenance requirements of customers, macroeconomic variations.

Accordingly, the present disclosure provides a method and a system for performing asset and energy management for an electrical distribution system. The present disclosure performs complex system analysis using non-linear dynamics on measurement data of the electrical distribution system. The present disclosure provides high accuracy in predicting future state of the electrical distribution system from the data, as the present disclosure considers the complex non-linear correlation between the variables through sparse regression. The present disclosure determines a number of system representations with variation of thresholding parameters, choice of variables selected for the sparse regression. Further, the present disclosure identifies a system representation that can ideally describe the complex non-linearity between the variables. The system representation can be used by a machine learning model to accurately predict future state of the electrical distribution system for performing the asset and energy management. The present disclosure can adapt to changing environment or complexities in a non-linear environment.

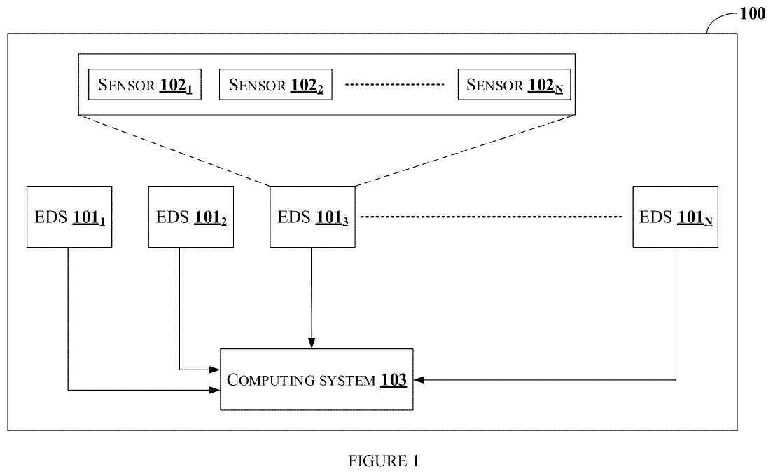

FIG. 1 illustrates an exemplary environment 100 for performing asset and energy management for an Electrical Distribution System (EDS), in accordance with some embodiments of the present disclosure. The exemplary environment 100 comprises electrical distribution systems 101₁, 101₂, 101₃ . . . 101_{N} (collectively referred as the electrical distribution system 101) and a computing system 103. The electrical distribution system 101 is an electrical network through which electrical energy is distributed to an end user for utilization. The electrical distribution system 101 comprises multiple components such as supply lines, transformers, switchgears, circuit breakers, switches, relays, fuses, cooling circuits, receptacles, utilization components, and the like. Components of the electrical distribution system 101 such as, switchgears, circuit breakers, switches, relays, fuses, and the like, protect other components of the electrical distribution system 101 such as the supply lines, the transformers, the utilization components, and the like, by monitoring the other components. The electrical distribution system 101 is associated with one or more sensors 102₁, 102₂ . . . 102_{N} (collectively referred as the one or more sensors 102). In an embodiment, the one or more sensors 102 may be implemented inside the electrical distribution system 101. For example, the one or more sensors 102 may include a current sensor, a voltage sensor, and the like. In another embodiment, the one or more sensors 102 may be implemented outside the electrical distribution system 101. For example, the one or more sensors 102 may include environmental sensors such as a temperature sensor, a humidity sensor, and the like.

The computing system 103 may be configured to perform the asset and energy management for the electrical distribution system 101. The computing system 103 may be a computing device such as, a laptop computer, a desktop computer, a Personal Computer (PC), a notebook, a smartphone, a tablet, e-book readers, a server, a network server, a cloud-based server, an edge computing device, a processing device, router, and the like. The computing system 103 may receive measurement data of a plurality of input variables of the electrical distribution system 101. The measurement data may be received from the one or more sensors 102 associated with the electrical distribution system 101. For example, the measurement data may include values of current, power, and the like. Further, the computing system 103 may generate a coefficient matrix for each output variable from one or more output variables. The one or more output variables may be used for asset and energy management. For example, the one or more output variables may include power consumption, health status, cable and contact life, trip event categorization of the electrical distribution system 101, and the like.

The coefficient matrix may be generated based on effects of the plurality of input variables on corresponding output variable, using sparse regression on the measurement data. The sparse regression may be used to identify most relevant input variables to predict a value of the output variable. The coefficient matrix comprises one or more input variables from the plurality of input variables. Further, the computing system 103 may determine a plurality of system representations for each output variable, based on the corresponding coefficient matrix. Each of the plurality of system representations indicates a relationship between the one or more input variables and the corresponding output variable. Also, the computing system 103 may identify a system representation from the plurality of system representations, for each output variable. The system representation may be used to train a machine learning model for predicting a value of the corresponding output variable, for performing the asset and energy management for the electrical distribution system 101.

In one implementation, the computing system 103 may be implemented as an edge computing platform. In such embodiment, the computing system 103 may perform the steps of identifying the system representation in an edge device by receiving the measurement data from the one or more sensors 102 associated with the electrical distribution system 101. The machine learning model may be implemented in the electrical distribution system 101 or a system associated with the electrical distribution system 101 (for example, a system in an industrial plant including the electrical distribution system 101). In another embodiment, the machine learning model may be implemented in the edge device. In another implementation, the computing system 103 may be implemented in a cloud computing platform. In such embodiment, the computing system 103 may perform the steps of identifying the system representation in a cloud server by receiving the measurement data from the one or more sensors 102 associated with the electrical distribution system 101. The machine learning model may be implemented in the electrical distribution system 101 or a system associated with the electrical distribution system 101 or the edge device. In another implementation, the computing system 103 may be implemented in the electrical distribution system 101.

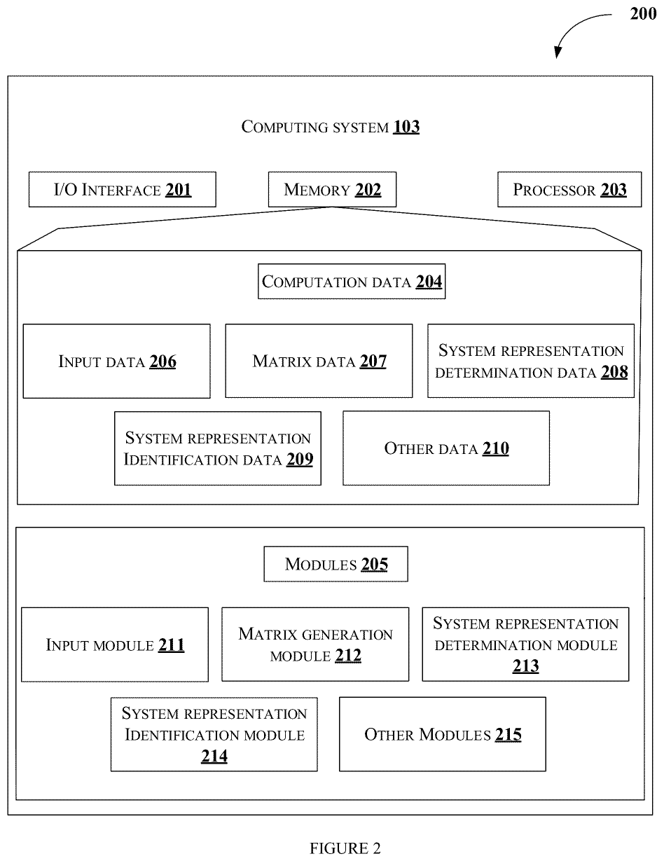

FIG. 2 illustrates a detailed diagram of the computing system 103 for performing the asset and energy management for the electrical distribution system 101, in accordance with some embodiments of the present disclosure. The computing system 103 comprises an Input/Output (I/O) interface 201, a memory 202, and a processor 203. In some embodiments, the memory 202 may be communicatively coupled to the processor 203. The memory 202 stores instructions executable by the processor 203. The processor 203 may comprise at least one data processor for executing program components for executing user or system-generated requests. The memory 202 may be communicatively coupled to the processor 203. The memory 202 stores instructions, executable by the processor 203, which, on execution, may cause the processor 203 to perform the asset and energy management for the electrical distribution system 101.

In an embodiment, the memory 202 may include one or more modules 205 and computation data 204. The one or more modules 205 may be configured to perform the steps of the present disclosure using the computation data 204, to perform the asset and energy management for the electrical distribution system 101. In an embodiment, each of the one or more modules 205 may be a hardware unit which may be outside the memory 202 and coupled with the computing system 103. As used herein, the term modules 205 refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 205 when configured with the described functionality defined in the present disclosure will result in a novel hardware. Further, the I/O interface 201 is coupled with the processor 203 through which an input signal or/and an output signal is communicated. For example, the computing system 103 may communicate with the one or more sensors 102 via the I/O interface 201.

In one implementation, the modules 205 may include, for example, an input module 211, a matrix generation module 212, a system representation determination module 213, a system representation identification module 214, and other modules 215. It will be appreciated that such aforementioned modules 205 may be represented as a single module or a combination of different modules. In one implementation, the computation data 204 may include, for example, input data 206, matrix data 207, system representation determination data 208, system representation identification data 209, and other data 210.

In an embodiment, the input module 211 may be configured to receive the measurement data of the plurality of input variables of the electrical distribution system 101 from the one or more sensors 102. The plurality of input variables may comprise at least one of, electrical variables, mechanical variables, and environmental variables, associated with the electrical distribution system 101. For example, the electrical variables may comprise variables such as current, voltage, power, power factor, harmonic distortions, energy, and the like. The mechanical variables may comprise wear and tear profiles, pressure, temperature, number of mechanical operations, and the like. The environmental variables may comprise variables such as temperature, humidity, and the like. In an example, consider that the electrical distribution system 101 comprises components such as, a circuit breaker, a fuse, a voltage regulator, and the like. The plurality of the input variables of the components may be received. In such case, the electrical variables of the circuit breaker may include arc current, short circuit events, contact resistance, and the like. The mechanical variables may include contact pressure, contact wear, contact temperature, and tear profiles, number of mechanical operations such as opening and closing of circuit breaker, opening and closing distance stroke, velocity of moving contacts, and the like. The environmental variables may include humidity, temperature, atmospheric pressure, and the like. The measurement data of the plurality of input variables may include values of the plurality of input variables. For example, a value of a short circuit current of the circuit breaker may be 100 KA. The short circuit events/faults may occur 3-4 times during life of the circuit breaker. In another example, the number of times the mechanical operations occur may vary from 10000-20000 during the life of the circuit breaker. The input module 211 may receive the measurement data of the plurality of input variables from the one or more sensors 102 associated with the electrical distribution system 101. For example, the one or more sensors 102 may comprise, a current sensor, a voltage sensor, a temperature sensor, a pressure sensor, a humidity sensor, and the like. In an embodiment, the one or more sensors 102 may be implemented in the electrical distribution system 101. For example, the one or more sensors 102 may include the current sensor and the voltage sensor. In another embodiment, the one or more sensors 102 may be implemented outside the electrical distribution system 101. For example, the one or more sensors 102 may include the temperature sensor and the humidity sensor. In an example, the temperature sensor and the humidity sensor may be placed in an enclosure of the electrical distribution system 101. The measurement data of the plurality of input variables of the electrical distribution system 101 may be stored as the input data 206 in the memory 202.

In an embodiment, the matrix generation module 212 may be configured to receive the input data 206 from the input module 211. Further, the matrix generation module 212 may be configured to generate the coefficient matrix for each output variable from one or more output variables used for asset and energy management. The one or more output variables used for asset and energy management may include, for example, energy consumption, the health status of the electrical distribution system 101, cable and contact life, trip event categorization, and the like. The matrix generation module 212 may generate the coefficient matrix based on effects of the plurality of input variables on corresponding output variable, using sparse regression on the measurement data. The sparse regression may identify most relevant variables to predict a value of the output variable.

Coefficients of the sparse regression are sparse i.e., many variables are set to zero, selecting only the most relevant variables. In the present disclosure, the sparse regression is used on the plurality of input variables that exhibit strong non-linearity. The sparse regression identifies one or more input variables from the plurality of input variables based on the effects of the plurality of input variables on corresponding output variable. For instance, consider that the one or more input variables identified from the plurality of input variables comprise current, pressure, voltage, temperature, arc current and resistance, power for the output variable energy consumption. The sparse regression may generate the coefficient matrix comprising a binary value for each of the plurality of input variables. For example, the matrix generation module 212 may generate the coefficient matrix with ‘0’ value assigned to variables such as pressure, temperature, arc current, and the like, and ‘1’ value assigned to the one or more variables such as current, voltage, resistance, power, and the like. The coefficient matrix generated may be stored as the matrix data 207 in the memory 202.

In an embodiment, the system representation determination module 213 may be configured to receive the matrix data 207 from the matrix generation module 212. Further, the system representation determination module 213 may be configured to determine the plurality of system representations for each output variable, based on the corresponding coefficient matrix. Each of the plurality of system representations indicates a relationship between the one or more input variables and the corresponding output variable. The system representation determination module 213 may determine one or more functions, where each function represents the relationship between the corresponding one or more input variables and the output variable. In an embodiment, the system representation determination module 213 may generate a candidate function matrix comprising the one or more functions associated with each of the corresponding one or more variables. A person skilled in the art will appreciate that the one or more functions may be generated in any other form and is not limited to matrix form. The coefficient matrix in combination with the candidate function matrix is used to generate determine the plurality of system representations. Each of the plurality of system representations comprise the one or more functions corresponding to each of the one or more input variables. Particularly, the plurality of system representations is a set of governing equations representing non-linearity of the electrical distribution system 101. Referring to the above-stated example, the output variable may be the energy consumption. The one or more variables may include the current, voltage, resistance, power, and the like. The functions may include, but not limited to, linear function, exponential function, logarithmic function, trigonometric function, and the like. The electrical distribution system 101 may be represented as a dynamical system of the form x′(t)=f(x(t)). For example, a system representation may be Y=six(x1)+cos 2(2*x2)+sin 3(5*x3).

In an example, the relationship between the current and the energy consumption may be defined by the linear function. The relationship between the resistance and the energy consumption may be defined by the linear function. In an example, arc resistance of the circuit breaker may exponentially vary with the temperature. Further, each of the plurality of system representations may include a weighted value associated with each of the one or more input variables, the weight indicating the relationship between the output variable and corresponding input variable. For example, consider when the function is a linear function. The weight may be “2”. The system representation may be y=2x. In an embodiment, the plurality of system representations may include differential equations. Exemplary system representations are shown below:

x0′=9.180+−0.119x0+0.026x1+−1.829x2+0.075x2\hat{ }2 Eq. (1)

x1′=479.889+4.629x0+6.717x1+−60.062x2+−0.012x0\hat{ }2+−0.011x0x1+−0.164x0x2+0.015x1\hat{ }2+0.116x1x2+1.793×2\hat{ }2 Eq. (2)

x2′=3.076+−0.006x0+−0.409x2+0.012x2\hat{ }2 Eq. (3)

In an embodiment, the plurality of system representations is determined by variations in the plurality of input variables and threshold values associated with the plurality of input variables selected for the sparse regression. The plurality of threshold values may indicate a degree of relevancy between the plurality of input variables and the output variable. In an embodiment, the one or more variables selected by performing the sparse regressions may be varied to test different conditions, implementations, and the like. The plurality of system representations determined for each output variable may be stored as the system representation determination data 208 in the memory 202.

In an embodiment, the system representation identification module 214 may be configured to receive the system representation determination data 208 from the system representation determination module 213. Further, the system representation identification module 214 may be configured to identify a system representation from the plurality of system representations, for each output variable. Firstly, the system representation identification module 214 may determine an accuracy level of each of the plurality of system representations in determining the value of the output variable for the measurement data. Next, the system representation identification module 214 may identify the system representation with maximum accuracy level, from the plurality of system representations. The system representation ideally describing the electrical distribution system 101 is identified. In an embodiment, Akaike Information Criterion (AIC) may be used to identify the system representation from the plurality of system representations using the accuracy level as criteria.

A person skilled in the art will appreciate that any known methods other than the above-mentioned method may be used to identify the system representation from the plurality of system representations. The system representation may be used to train the machine learning model for predicting a value of the corresponding output variable using one or more machine learning techniques. For example, the machine learning model trained using the system representation may predict the values of the corresponding output variable to monitor asset life, cable & contact life, trip event categorization, energy consumption, and the like. The system representation identified may be simulated for future states to predict the value of the one or more output variables. The present disclosure identifies an ideal system representation that can be used to simulate future time states of behavior of the electrical distribution system 101 and hence can be used to accurately predict system output for desired performance such as, for the asset and energy management of the electrical distribution system 101.

The other data 210 may store data, including temporary data and temporary files, generated by the one or more modules 205 for performing the various functions of the computing system 103. The one or more modules 205 may also include the other modules 215 to perform various miscellaneous functionalities of the computing system 103. The other data 210 may be stored in the memory 202. It will be appreciated that the one or more modules 205 may be represented as a single module or a combination of different modules.

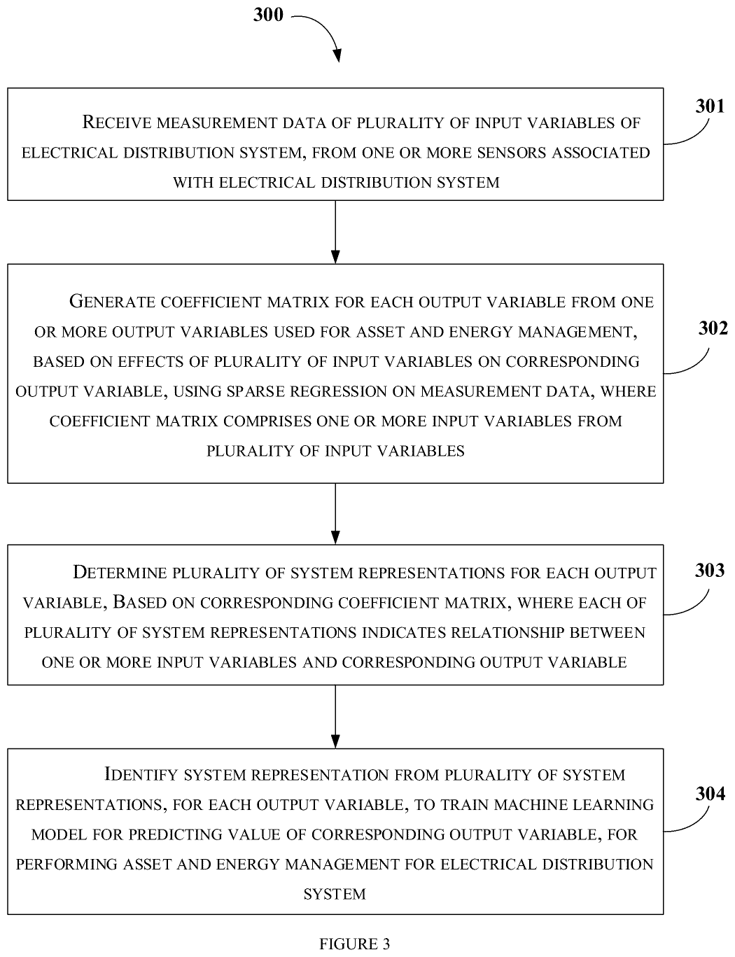

FIG. 3 shows an exemplary flow chart illustrating method steps for performing the asset and energy management for the electrical distribution system 101, in accordance with some embodiments of the present disclosure. As illustrated in FIG. 3, the method 300 may comprise one or more steps. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 301, the computing system 103 may receive the measurement data of the plurality of input variables of the electrical distribution system 101. The plurality of input variables may comprise at least one of, electrical variables, mechanical variables, and environmental variables, associated with the electrical distribution system 101. The computing system 103 may receive the measurement data of the plurality of input variables from the one or more sensors 102 associated with the electrical distribution system 101.

At step 302, the computing system 103 may generate the coefficient matrix for each output variable from one or more output variables used for asset and energy management. The computing system 103 may generate the coefficient matrix based on effects of the plurality of input variables on corresponding output variable, using sparse regression on the measurement data. The sparse regression may be used to generate the coefficient matrix based on selected threshold values for the plurality of input variables and the variations in the plurality of the input variables.

At step 303, the computing system 103 may determine the plurality of system representations for each output variable, based on the corresponding coefficient matrix. Each of the plurality of system representations indicates a relationship between the one or more input variables and the corresponding output variable. The computing system 103 may determine one or more functions, where each function represents the relationship between the corresponding one or more input variables and the output variable. In an embodiment, the computing system 103 may generate the candidate function matrix comprising the one or more functions associated with each of the corresponding one or more variables. A person skilled in the art will appreciate that the one or more functions may be generated in any other form and is not limited to matrix form. The coefficient matrix in combination with the candidate function matrix is used to generate determine the plurality of system representations. Each of the plurality of system representations comprise one or more functions corresponding to each of the one or more input variables. Each function represents the relationship between the corresponding one or more input variables and the output variable. The plurality of system representations may include differential equations. In an embodiment, the plurality of system representations is determined by variations in the plurality of input variables and threshold values associated with the plurality of input variables selected for the sparse regression.

At step 304, the computing system 103 may identify a system representation from the plurality of system representations, for each output variable. The computing system 103 may determine the accuracy level of each of the plurality of system representations in determining the value of the output variable for the measurement data. Further, the computing system 103 may identify the system representation with maximum accuracy level, from the plurality of system representations. The system representation may be used to train a machine learning model for predicting a value of the corresponding output variable using one or more machine learning techniques. The machine learning model may be trained using the system representation. Particularly, the machine learning model may simulate the system representation for future states to predict the value of the one or more output variables.

### Computer System

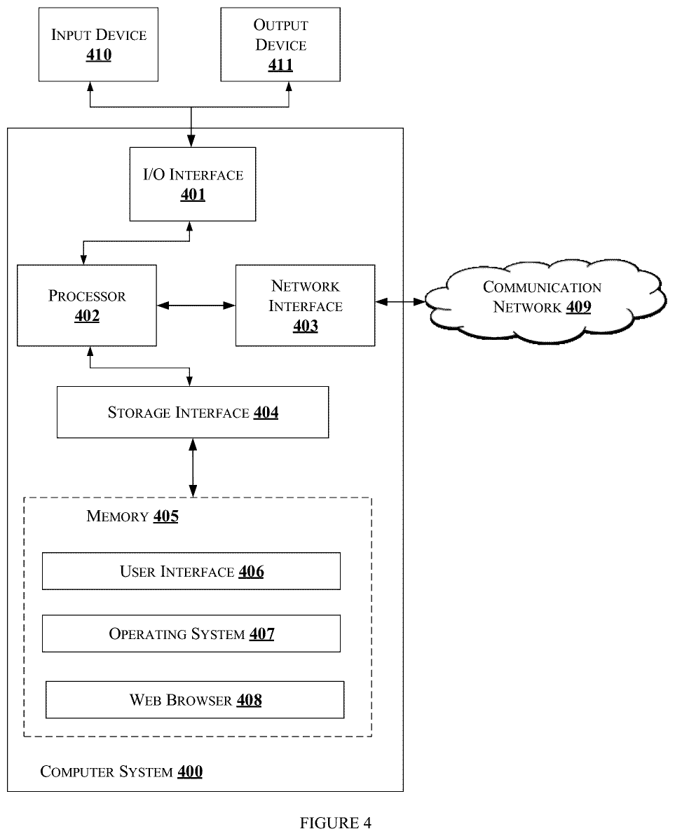

FIG. 4 illustrates a block diagram of an exemplary computer system 400 for implementing embodiments consistent with the present disclosure. In an embodiment, the computer system 400 may be used to implement the computing system 103. Thus, the computer system 400 may be used for performing the asset and energy management for the electrical distribution system 101. In an embodiment, the computer system 400 may receive the measurement data of the plurality of input variables from the one or more sensors 102 over the communication network 409, when the computer system 400 is implemented in the edge computing platform or the cloud computing platform. In another embodiment, the computer system 400 may be implemented in the electrical distribution system 101. The computer system 400 may comprise a Central Processing Unit 402 (also referred as “CPU” or “processor”). The processor 402 may comprise at least one data processor. The processor 402 may include specialized processing units such as integrated system (bus) controllers, memory management control units, floating point units, graphics processing units, digital signal processing units, etc.

The processor 402 may be disposed in communication with one or more input/output (I/O) devices (not shown) via I/O interface 401. The I/O interface 401 may employ communication protocols/methods such as, without limitation, audio, analog, digital, mono-aural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 401, the computer system 400 may communicate with one or more I/O devices. For example, the input device 410 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, sensors, etc. The output device 411 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 402 may be disposed in communication with the communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 409 may include, without limitation, a direct interconnection, local area network (LAN), wide area network (WAN), wireless network (e.g., using Wireless Application Protocol), the Internet, etc. The network interface 403 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, Bluetooth mesh, ZigBec, etc.

The communication network 409 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface 406, an operating system 407, web browser 408 etc. In some embodiments, computer system 400 may store user/application data, such as, the data, variables, records, etc., as described in this disclosure. Such databases may be implemented as fault-tolerant, relational, scalable, secure databases such as Oracle® or Sybase®.

The operating system 407 may facilitate resource management and operation of the computer system 400. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLER ANDROID™, BLACKBERRY® OS, or the like.

In some embodiments, the computer system 400 may implement the web browser 408 stored program component. The web browser 408 may be a hypertext viewing application, for example MICROSOFT® INTERNET EXPLORER™, GOOGLE® CHROME™0, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX™, DHTML™, ADOBE® FLASH™, JAVASCRIPT™, JAVA™, Application Programming Interfaces (APIs), etc. In some embodiments, the computer system 400 may implement a mail server (not shown in Figure) stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client stored program component. The mail client (not shown in Figure) may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

Embodiments of the present disclosure provide a method and system for performing asset and energy management for an electrical distribution system. The present disclosure performs complex system analysis using non-linear dynamics-based approaches on the measurement data associated with the electrical distribution system. The present disclosure provides high accuracy in predicting future state of the electrical distribution system from the measurement data, as the present disclosure considers the complex non-linearity between the variables through sparse regression. Particularly, the present disclosure determines a number of system representations with variation of thresholding parameters, choice of variables selected for the sparse regression. Further, the present disclosure identifies an ideal system representation that describes the complex non-linearity between the variables and models system behavior. The system representation can be used by a machine learning model to accurately predict future state of the electrical distribution system for performing the asset and energy management. Further, the present disclosure can adapt to changing environment or complexities that occurs generally in non-linear environment, by capturing real-time changes in the environment.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise. A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERRAL NUMERALS

| Referral number | Description |
|---|---|
| 100 | Exemplary environment |
| 101 | electrical distribution system |
| 102 | One or more sensors |
| 103 | Computing system |
| 200 | Detailed diagram |
| 201 | I/O interface |
| 202 | Processor |
| 203 | Memory |
| 204 | Computation data |
| 205 | Modules |
| 206 | Input data |
| 207 | Matrix data |
| 208 | System representation determination data |
| 209 | System representation identification data |
| 210 | Other data |
| 211 | Input module |
| 212 | Matrix generation module |
| 213 | System representation determination module |
| 214 | System representation identification module |
| 215 | Other modules |
| 400 | Computer system |
| 401 | I/O interface |
| 402 | Processor |
| 403 | Network interface |
| 404 | Storage interface |
| 405 | Memory |
| 406 | User interface |
| 407 | Operating system |
| 408 | Web browser |
| 409 | Communication network |
| 410 | Input device |
| 411 | Output device |

What is claimed is:

1. A method for performing asset and energy management for an electrical distribution system, the method comprising:
receiving measurement data of a plurality of input variables of an electrical distribution system from one or more sensors associated with the electrical distribution system;
generating a coefficient matrix for each output variable from one or more output variables used for asset and energy management, based on effects of the plurality of input variables on corresponding output variable, using sparse regression on the measurement data, wherein the coefficient matrix comprises one or more input variables from the plurality of input variables;
determining a plurality of system representations for each output variable, based on the corresponding coefficient matrix, wherein each of the plurality of system representations indicates a relationship between the one or more input variables and the corresponding output variable; and
identifying a system representation from the plurality of system representations, for each output variable, to train a machine learning model for predicting a value of the corresponding output variable, for performing the asset and energy management for the electrical distribution system.

2. The method as claimed in claim 1, wherein the plurality of input variables comprises at least one of, electrical variables, mechanical variables, and environmental variables, associated with the electrical distribution system.

3. The method as claimed in claim 1, wherein each of the plurality of system representations comprises one or more functions corresponding to each of the one or more input variables, and wherein each function represents the relationship between the corresponding one or more input variables and the output variable.

4. The method as claimed in claim 1, wherein the plurality of system representations is determined by variations in the plurality of input variables and threshold values associated with the plurality of input variables selected for the sparse regression.

5. The method as claimed in claim 1, wherein identifying the system representation from the plurality of system representations comprises:
determining an accuracy level of each of the plurality of system representations in determining the value of the output variable for the measurement data; and
identifying the system representation with maximum accuracy level, from the plurality of system representations.

6. The method as claimed in claim 1, wherein the value of the corresponding output variable is predicted using one or more machine learning techniques.

7. A computing system for performing asset and energy management for an electrical distribution system, the computing system comprising:
a processor; and
a memory, wherein the memory stores processor-executable instructions, which, on execution, cause the processor to:
receive measurement data of a plurality of input variables of an electrical distribution system from one or more sensors associated with the electrical distribution system;
generate a coefficient matrix for each output variable from one or more output variables used for asset and energy management, based on effects of the plurality of input variables on corresponding output variable, using sparse regression on the measurement data, wherein the coefficient matrix comprises one or more input variables from the plurality of input variables;
determine a plurality of system representations for each output variable, based on the corresponding coefficient matrix, wherein each of the plurality of system representations indicates a relationship between the one or more input variables and the corresponding output variable; and
identify a system representation from the plurality of system representations, for each output variable, to train a machine learning model for predicting a value of the corresponding output variable, for performing the asset and energy management for the electrical distribution system.

8. The computing system as claimed in claim 7, wherein the plurality of input variables comprises at least one of, electrical variables, mechanical variables, and environmental variables, associated with the electrical distribution system.

9. The computing system as claimed in claim 7, wherein each of the plurality of system representations comprises one or more functions corresponding to each of the one or more input variables, and wherein each function represents the relationship between the corresponding one or more input variables and the output variable.

10. The computing system as claimed in claim 7, wherein the processor determines the plurality of system representations by variations in the plurality of input variables and threshold values associated with the plurality of input variables selected for the sparse regression.

11. The computing system as claimed in claim 7, wherein the processor identifies the system representation from the plurality of system representations by:
determining an accuracy level of each of the plurality of system representations in determining the value of the output variable for the measurement data; and
identifying the system representation with maximum accuracy level, from the plurality of system representations.

12. The computing system as claimed in claim 7, implemented in one of, an edge computing platform, a cloud computing platform, and the electrical distribution system.

13. The computing system as claimed in claim 7, wherein the processor predicts the value of the corresponding output variable using one or more machine learning techniques.
